(19) United States
(12) Patent Application Publication
(10) Pub. No.: US 2006/0231194 A1
(43) Pub. Date: Oct. 19, 2006

(54) Method for causing metallized pattern to be pulled out and attached on gas permeable and moisture absorptive material

(75) Inventor: Tom Ku, Hsinchu (TW)

Correspondence Address: BRUCE H. TROXELL;SUITE 1404, 5205 LEESBURG PIKE, FALLS CHURCH, VA, 22041, US

(73) Assignee: Klaser Technology Inc.

(21) Appl. No.: 11/106,561

(22) Filed: Apr. 15, 2005

(51) Int. Cl. B32B 37/00

(52) U.S. Cl. 156/247

(57) ABSTRACT

A method for forming fine lines on a gas permeable and moisture absorptive material comprises the following steps: spreading a water-based resin layer on one face of a molding plate with a metallized pattern; covering a carrier made from a gas permeable and moisture absorptive material on the water-based resin layer; allowing the water contained in the water-based resin layer to be carried away; removing the molding plate after said water-based resin layer is harden to be a solidified resin layer and combined firmly with the carrier and the metallized pattern, the metallized pattern on said molding plate being then pulled out and attached to the solidified resin layer to cause the carrier to have the metallized pattern.

### FIELD OF THE INVENTION

The present invention relates to a method for causing a metallized pattern to be combined on a material, and more particularly to a method for causing a metallized pattern to be pulled out and attached on a gas permeable and moisture absorptive material.

### DESCRIPTION OF RELATED ART

The U.S. Patent Pub. No. 20040241404 discloses a paper with holographic pattern and manufacture of it, in which a separation type metallized holographic image is caused to transfer from a mother film to a paper by means of illumination combination of UV resin and UV light.

An more expensive resin material needs to be used and more expensive environment and facilities are also needed in the manufacturing operation as well as a rather energy consumptive characteristic exists in the manufacturing method causing the separation type metallized holographic image to be transferred by means of the illumination combination of UV resin and UV light mentioned above.

The U.S. Pat. No. 5,939,177 discloses a holographically transferable images; a metallized holographic image spread with an adhesive layer is transferred onto a package paper by means of heating and pressuring to cause the package paper to have a holographic image thereon.

The U.S. Pat. No. 6,558,788 discloses a holographic transfer film. A holographic image is disposed at the outer layer of a transfer film and a metal film is electroplated on the outer layer with the holographic image. A glue or adhesive is spread on a carrier to stick a metal film with a holographic image to cause the metal film with the holographic image to be transferred from the transfer film to the carrier.

The adhesive and heating and pressuring facilities need to be used while sticking the metal film with the holographic image with the glue and the adhesive mentioned above, the production cost is higher and the manufacturing speed is slower. Besides, the glue or the adhesive made from an organic solvent is used in the transferring process of the holographic image, volatile gas can rather contaminate the environment.

### SUMMARY OF THE INVENTION

For providing a method for pulling out and attaching metallized pattern on a gas permeable and moisture absorptive material, making full use of the gas permeable and moisture absorptive characteristics of the material and needing no expensive material and facility, the metallized pattern can be easily and quickly pulled out and attached on the gas permeable and moisture absorptive material and the environment can rather not be contaminated in the middle of the manufacturing process, the present invention is proposed.

The main object of the present invention is provide a method for pulling out and attaching a metallized pattern on a gas permeable and moisture absorptive material, enabling the operation to be simpler and the metallized pattern to be more quickly pulled out and attached while manufacturing.

Another object of the present invention is to provide a method for pulling out and attaching a metallized pattern on a gas permeable and moisture absorptive material, needing no expensive material and facility to be used, it is rather economical.

Still another object of the present invention is to provide a method for pulling out and attaching a metallized pattern on a gas permeable and moisture absorptive material, needing no environment polluting organic solvent, it is of environmental consciousness.

### BRIEF DESCRIPTION OF THE DRAWINGS

The present invention can be more fully understood by reference to the following description and accompanying drawings, in which:

FIGS. 1A to 1F are schematic views, respectively showing a structure in each step in a method for pulling out and attaching a metallized pattern on a gas permeable and moisture absorptive material according to the present invention.

### DETAILED DESCRIPTION OF THE PREFERRED EMBODIMENTS

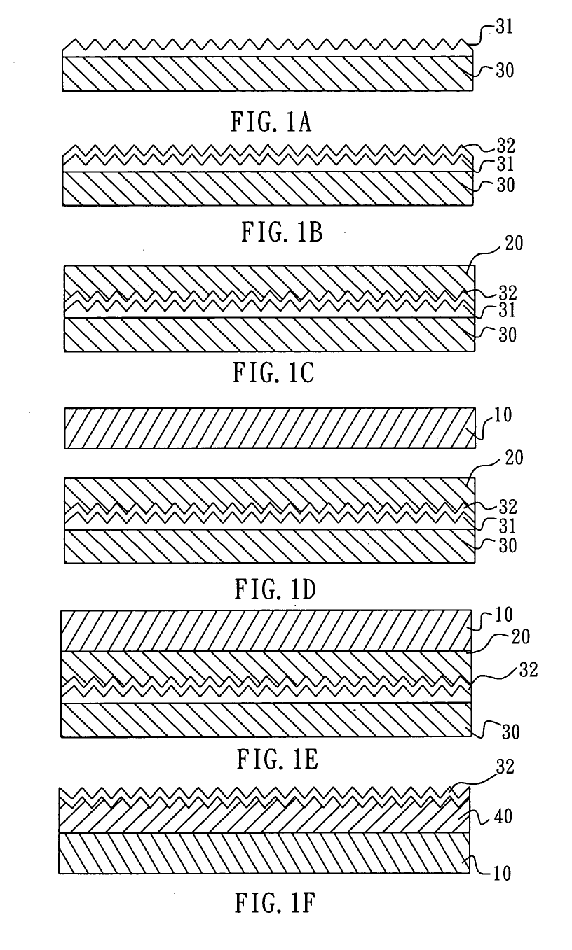

Please refer to FIGS. 1A to 1F. A method for pulling out and attaching a metallized pattern on a gas permeable and moisture absorptive material according to the present invention comprises the following steps:
1. allowing a molding plate 30 with a pattern 31 to be electroplated with a metal material, for example, evaporation plated with aluminum, zinc sulfide and etc to cause the outer surface of the pattern 31 to have a metallized pattern 32, as FIGS. 1A and 1B show.
2. allowing one face of the modling plate 30 with the metallized pattern 32 to be spread with a water-based resin layer 20 such as a water-based resin layer containing polyvinyl alcohol resin, as FIG. 1C show;
3. covering a carrier 10 made from a gas permeable and moisture absorptive material on the water-based resin 20, as FIGS. 1D and 1E show;
4. allowing the water contained in the water-based resin layer 20 to be evaporated and carried away by means of heat energy or the gas permeable and the moisture absorptive characteristics of the carrier 10 itself, as FIG. 1E shows;
5. removing the molding plate 30 after the water-based resin layer 20 is hardened to be a solidified resin layer 40 and combined firmly with the carrier 10 and the metallized pattern 32; because the material utilized to form the pattern 31 mentioned above is not good with regard to the adhesion of a metal material, the metallized pattern 32 on the molding plate 30 is then pulled out and attached to the solidified resin layer 40 to cause the carrier to have the metallized pattern 32, as FIG. 1F shows.

The carrier 10 according to the present invention can be one of a variety of gas permeable and moisture absorptive materials, such as paper, cloth, wood, plastic film, leather, stone, concrete and rubber.

The molding plate 30 according to the present invention can be one of a variety of materials, such as metal, plastic film, the surface thereof is combined with a pattern 31 that is not good with regard to the adhesion of a metal material.

The gas permeable and moisture absorptive characteristics of the carrier 10 of the present invention are used to allow the water-based resin to be permeated into the gaps of the fibers of the carrier 10 when the water-based resin layer 20 is spread thereon to broadening the evaporation area of the water contained in the water-based resin so that the evaporation efficiency can be increased. Therefore, the water contain in the water-based resin layer 20 can quickly and easily be carried away to harden the resin layer 20 without needing to use expensive materials and facilities and the water-based resin layer 20 can stably be combined with the carrier 10 by means of the resin penetrated into the gaps of the fibers of the carrier 10. Thereby, the operation of the manufacturing causing the metallized pattern 32 to be pulled out and attached onto the gas permeable and moisture absorptive carrier 10 is simplifier and faster. Besides, too large pressure exerted on the molding plate 30 and the water-based resin layer 20 is unnecessary according to the present invention, the metallized pattern 32 on the molding plate 30 can then be pulled out and attached onto the water-based resin layer 20; the lines 31 on the molding plate 30 can rather not be damaged so that the molding plate 30 can be allowed to use repeatedly to save the production cost.

The water-based resin according to the present invention is made by taking pure water as a solvent to dissolve resin into it and without using an organic solvent that is pollutant to the environment.

The water in the water-based resin is caused to evaporate in the manufacturing process according to the present invention, only water vapor that is harmless to the environment is yielded and no organic solvent gas that is pollutant to the environment can be yielded so that it is rather of environmental consciousness.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for forming fine lines on a gas permeable and moisture absorptive material, comprising:
(1) spreading a water-based resin layer onto one face of a molding plate with a metallized pattern;
(2) covering a carrier made from a gas permeable and moisture absorptive material on said water-based resin layer;
(3) allowing the water contained in said water-based resin layer to be carried away;
(4) removing said molding plate after said water-based resin layer is harden to be a solidified resin layer and combined firmly with said carrier and said metallized pattern; the material used to form a pattern of said molding plate is not good with regard to the adhesion of a metal material so that said metallized pattern on said molding plate being then pulled out and attached to said solidified resin layer to cause said carrier to have said metallized pattern.

2. The method according to claim 1, further comprising a step before said step (1):
allowing said molding plate with said pattern to be electroplated with a metal material to cause the outer surface of said pattern to have said metallized pattern thereon.

3. The method according to claim 1, wherein heat energy is utilized to evaporate said water in said step (2).

4. The method according to claim 1, wherein said carrier is utilized to absorb said water and further to cause said absorbed water to be evaporated in said step (2).

5. The method according to claim 1, wherein said carrier is paper.

6. The method according to claim 1, wherein said carrier is cloth.

7. The method according to claim 1, wherein said carrier is wood.

8. The method according to claim 1, wherein said carrier is plastic film.

9. The method according to claim 1, wherein said carrier is leather.

10. The method according to claim 1, wherein said carrier is stone.

11. The method according to claim 1, wherein said carrier is concrete.

12. The method according to claim 1, wherein said carrier is rubber.

13. The method according to claim 2, wherein said molding plate with said pattern is electroplated with a metal material again after said metallized pattern on said molding plate is pulled out and attached onto said solidified resin layer so as to allow said molding plate with said pattern to be reused.
